(19) United States
(12) Patent Application Publication
(10) Pub. No.: US 2016/0028944 A1
(43) Pub. Date: Jan. 28, 2016

(54) IMAGE PROCESSING APPARATUS, IMAGING APPARATUS, AND IMAGE PROCESSING METHOD

(71) Applicant: CANON KABUSHIKI KAISHA, Tokyo (JP)

(72) Inventor: Koichiro Ikeda, Tokyo (JP)

(21) Appl. No.: 14/806,513

(22) Filed: Jul. 22, 2015

(30) Foreign Application Priority Data
Jul. 28, 2014 (JP) 2014-153296

(51) Int. Cl. H04N 5/232; H04N 5/262

(52) U.S. Cl. CPC H04N 5/23219; H04N 5/2621

(57) ABSTRACT

An image processing apparatus is provided with an image acquiring unit configured to acquire an image, a blurring processing unit configured to apply blurring processing to a skin area of an object person and a background area included in the image, and a control unit configured to control a blurring amount of the blurring processing for each of the areas, wherein the control unit controls the blurring amount of the blurring processing so that a blurring amount in the skin area of the object person becomes smaller than a blurring amount in the background area.

### BACKGROUND OF THE INVENTION

1. Field of the Invention

The present disclosure generally relates to techniques for giving a blur effect to a background area in captured image data and blurring a skin area of an object person to smooth the skin area and, more particularly, to an image processing apparatus, an imaging apparatus, and an image processing method.

2. Description of the Related Art

Conventionally, there has been a function of artificially giving a blurring effect to a background area in a captured image as a function provided in an imaging apparatus such as a digital camera and a digital video camera.

Generally, in an imaging apparatus that has a large imaging element such as a single-lens reflex camera, the depth of field is narrowed by opening an aperture to increase the focal length, and it is thus relatively easy to capture an image whose background other than a focused object is blurred. On the other hand, in an imaging apparatus that has a small imaging element such as a compact digital camera, even if the above method is used, the field of depth tends to be deep. Thus, it is difficult to capture an image whose background is blurred.

In view of the above problem, there have been proposed techniques for determining an object area and a background area in a captured image and applying blurring processing to the background area to thereby enable an image whose background is blurred to be acquired even in an imaging apparatus having a small imaging element.

Further, there is a function of performing image processing on a skin area of an object person to smooth the skin to thereby give a skin-beautifying effect. For example, Japanese Patent Application Laid-Open No. 2004-303193 discloses a method for detecting a skin area of an object person and applying blurring processing on the skin area to smooth the skin area. This function enables wrinkles or flecks on the face of the object person to be invisible.

When a technique for blurring a background area in an image and a technique for applying blurring processing to a skin area of an object person to smooth the skin area to thereby give a skin-beautifying effect are simultaneously used in the single captured image, the following problem occurs.

Specifically, when the blurring processing is performed on the skin area of the object person, the face of the object person has a relatively blurred impression compared to an impression before the blurring processing. In particular, when the blurring amount in the skin area of the object person is larger than the blurring amount in the background area, an impression of the object person being out of focus is disadvantageously given.

An object of the present invention is to simultaneously perform blurring processing on a background area and blurring processing on a skin area of an object person in an image without giving an impression of the object person being out of focus.

### SUMMARY OF THE INVENTION

According to an aspect of the present disclosure, an image processing apparatus is provided with an image acquiring unit configured to acquire an image, a blurring processing unit configured to apply blurring processing to a skin area of an object person and a background area included in the image, and a control unit configured to control a blurring amount of the blurring processing for each of the areas, wherein the control unit controls the blurring amount of the blurring processing so that a blurring amount in the skin area of the object person becomes smaller than a blurring amount in the background area.

Further features of the present disclosure will become apparent from the following description of exemplary embodiments (with reference to the attached drawings).

### BRIEF DESCRIPTION OF THE DRAWINGS

FIG. 1 is a block diagram illustrating an example of the configuration of an image processing apparatus according to an embodiment of the present disclosure.

FIG. 2 is a block diagram illustrating an example of the configuration of a skin area smoothing processing unit.

FIG. 3 is a block diagram illustrating an example of the configuration of a background blurring processing unit.

FIG. 4 is a diagram illustrating a processing flow in the skin area smoothing processing unit and the background blurring processing unit.

FIG. 5 is a diagram illustrating an example of face range detection in an original image.

FIG. 6 is a diagram illustrating an example of skin area detection processing in the original image.

FIG. 7 is a diagram illustrating a processing flow in background area detection processing.

FIGS. 8A and 8B are diagrams illustrating tables for obtaining a blur addition parameter and a minimum blur addition parameter.

FIG. 9 is a diagram illustrating a table for obtaining a maximum smoothing parameter.

### DESCRIPTION OF THE EMBODIMENTS

An image processing apparatus according to embodiments of the present disclosure will be described in detail with reference to the drawings. Although, in the following description, an example in which the image processing apparatus of the present invention is applied to a digital camera will be described, the present disclosure is not limited thereto.

### First Embodiment

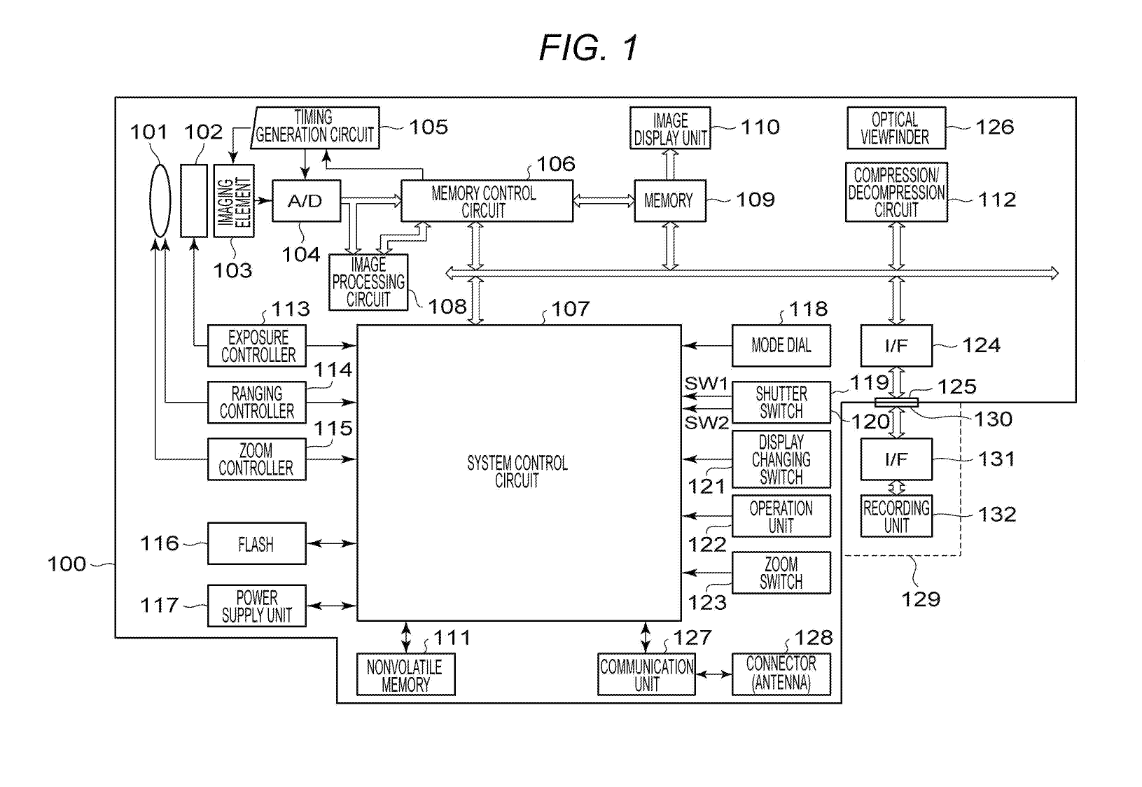

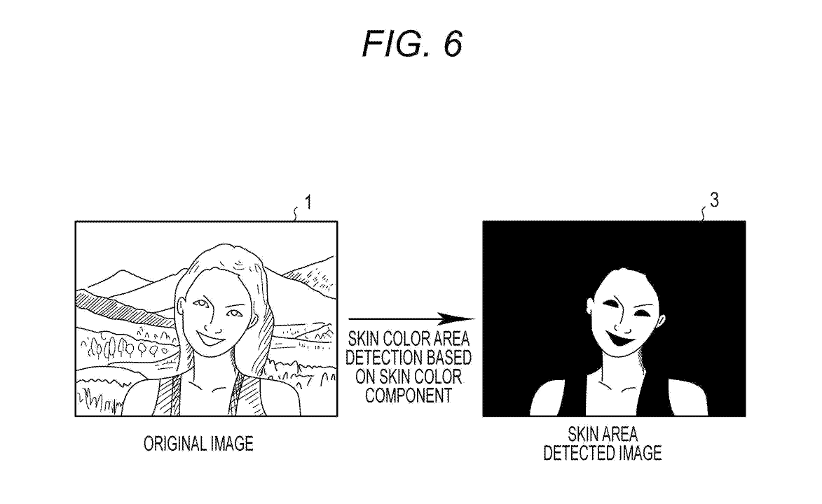

An image processing apparatus 100 according to a first embodiment will be described with reference to FIGS. 1 to 8B.

FIG. 1 is a diagram illustrating an example of the configuration of the image processing apparatus 100.

The image processing apparatus 100 is provided with a taking lens 101, a mechanical shutter 102 which has an aperture function, an imaging element 103 which converts an optical image into an electrical signal, and an analog to digital (A/D) converter 104 which converts an analog signal output from the imaging element 103 into a digital signal.

The image processing apparatus 100 is further provided with a timing generation circuit 105 which supplies a clock signal and a control signal to the imaging element 103 which acquires an image by image capture and the A/D converter 104. The timing generation circuit 105 is controlled by a memory control circuit 106 and a system control circuit 107. Except for the mechanical shutter 102, accumulation time can be controlled by controlling a rest timing of the imaging element 103 by the timing generation circuit 105 as an electronic shutter. This can be used in moving image shooting.

An image processing circuit 108 performs predetermined pixel interpolation processing or color conversion processing on data from the A/D converter 104 or data from the memory control circuit 106. The image processing circuit 108 performs cut-out processing and zooming processing of an image to achieve an electronic zoom function.

Further, the image processing circuit 108 performs predetermined arithmetic processing using captured image data. On the basis of the obtained arithmetic operation result, the system control circuit 107 controls an exposure controller 113 and a ranging controller 114 to perform AF (autofocus) processing, AE (automatic exposure) processing, and EF (electronic flash pre-emission) processing of a TTL (transistor-transistor logic) system. Furthermore, the image processing circuit 108 performs predetermined arithmetic processing using the captured image data, and also performs auto white balance (AWB) processing of a TTL system on the basis of the obtained arithmetic operation result.

The memory control circuit 106 controls the A/D converter 104, the timing generation circuit 105, the image processing circuit 108, a memory 109, and a compression/decompression circuit 112. Data output from the A/D converter 104 is written into the memory 109 through the image processing circuit 108 and the memory control circuit 106 or directly through the memory control circuit 106.

An image display unit 110 which includes, for example, an LCD displays image data for display which has been written into the memory 109 through the memory control circuit 106. Sequentially displaying captured image data on the image display unit 110 allows the image display unit 110 to function as an electronic viewfinder. The image display unit 110 is capable of turning ON/OFF display in accordance with an instruction from the system control circuit 107. When the display is turned OFF, power consumption of the image processing apparatus 100 can be significantly reduced. As used herein, the term “unit” generally refers to any combination of software, firmware, hardware, or other component, such as circuitry, that is used to effectuate a purpose.

The memory 109 for storing a still image or a moving image has a storage capacity sufficient to store a predetermined number of still images or a predetermined time of moving image. Accordingly, even when continuous shooting in which a plurality of still images are continuously captured or panoramic shooting is preformed, high speed and large amount image writing can be performed with respect to the memory 109. The memory 109 can also be used as a work area of the system control circuit 107.

Program codes to be executed by the system control circuit 107 are written in a nonvolatile memory 111 which includes, for example, a Flash ROM. The system control circuit 107 sequentially reads and executes the program codes. An area for storing system information and an area for storing user-setting information are provided inside the nonvolatile memory 111 to read and restore various information items or settings at the next start-up time.

The compression/decompression circuit 112 which compresses or decompresses image data by, for example, adaptive discrete cosine transformation (ADCT) reads an image stored in the memory 109 to perform compression processing or decompression processing on the read image and writes the processed data into the memory 109.

The exposure controller 113 which controls the shutter 102 having an aperture function also has a flash exposure control function by interlocking with a flash 116.

The ranging controller 114 which controls focusing of the taking lens 101 and a zoom controller 115 which controls zooming of the taking lens 101 are provided.

The flash 116 also has a projector function of projecting AF assist light and a flash exposure control function. The exposure controller 113 and the ranging controller 114 are controlled by using a TTL system. On the basis of an arithmetic operation result obtained by operating captured image data by the image processing circuit 108, the system control circuit 107 controls the exposure controller 113 and the ranging controller 114.

The system control circuit 107 controls the entire image processing apparatus 100.

A mode dial 118, a shutter switch SW(1) 119, a shutter switch SW(2) 120, a display changing switch 121, an operation unit 122, and a zoom switch 123 are operation devices for inputting various operation instructions from the system control circuit 107 and include a switch or a dial, a touch panel, pointing by sight line detection, or a voice recognition device, or a combination thereof.

Hereinbelow, these operation devices will be described in detail.

The mode dial switch 118 is capable of setting switching between functional modes such as power-off, an automatic shooting mode, a shooting mode, an HDR shooting mode, a panoramic shooting mode, a moving image shooting mode, a playback mode, and a personal computer (PC)-connection mode.

Operating the shutter switch SW(1) 119 brings an ON state in the middle of the operation of a shutter button to instruct the start of operations of, for example, autofocus (AF) processing, automatic exposure (AE) processing, and auto white balance (AWB) processing.

Operating the shutter switch SW(2) 120 brings an ON state in the completion of the operation of the shutter button. In flash shooting, the imaging element 103 is exposed for an exposure time determined by AE processing after pre-flash (EF) processing. In flash shooting, flash is performed during the exposure period and light-shielding is performed by the exposure controller 113 simultaneously with the end of the exposure period to finish the exposure to the imaging element 103.

The start of the operation of a series of processing as follows is instructed: write processing in which a signal read from the imaging element 103 is written into the memory 109 as image data through the A/D converter 104 and the memory control circuit 106; development processing using arithmetic operation in the image processing circuit 108 or the memory control circuit 106; compression processing in which compression of the image data read from the memory 109 is performed by the compression/decompression circuit 112; and recording processing in which the compressed image data is written into a recording medium 129.

The display changing switch 121 is capable of switching the display of the image display unit 110. This function enables power saving when image capture is performed using an optical viewfinder 126 by cutting off power supply to the image display unit 110 which includes, for example, a liquid crystal display (LCD).

The operation unit 122 which includes, for example, various buttons, a touch panel, and a rotary dial includes, for example, a menu button, a set button, a macro button, a multi-screen reproduction page-break button, a flash setting button, a single shooting/continuous shooting/self-timer switching button. The operation unit 122 also has, for example, a menu moving plus (+) button, a menu moving minus (−) button, a playback image moving plus (+) button, a playback image moving minus (−) button, a captured image quality selection button, an exposure compensation button, and a date/time setting button.

The zoom switch 123 is a zoom operation unit through which a user instructs magnification change in a captured image. The zoom switch 123 includes a telescopic switch which changes the image-pickup field angle to a telephoto direction and a wide switch which changes the image-pickup filed angle to a wide-angle direction. Change of the image-pickup filed angle of the taking lens 101 is instructed to the zoom controller 115 by using the zoom switch 123, which becomes a trigger for performing an optical zoom operation, and also becomes a trigger for cut-out of an image by the image processing circuit 108 or electronic zooming change of the image-pickup field angle by pixel interpolation processing.

A power supply unit 117 includes, for example, a primary battery such as an alkaline battery, a secondary battery such as a NiCd (nickel cadmium) battery, a NiMH (nickel metal hydride) battery and Li (lithium) ion battery, and an AC (alternating current) adapter.

An interface (I/F) 124 is an interface with a recoding medium such as a memory card and a hard disk. The I/F 124 performs connection to the recording medium such as a memory card and a hard disk through a connector 125.

Using the optical viewfinder 126 enables image capture to be performed without using an electronic viewfinder function by the image display unit 110.

A communication unit 127 has various communication functions such as a USB (universal serial bus), an IEEE1394 (Institute of Electrical and Electronics Engineers), a LAN (local area network), and wireless communication.

A connector (antenna) 128 is a connector which connects the image processing apparatus 100 to another device by the communication unit 127 or an antenna in the case of wireless communication.

A recording medium 129 is, for example, a memory card or a hard disk. The recording medium 129 includes a connector 130 which performs connection to the image processing apparatus 100, an interface 131 with the image processing apparatus 100, and a recording unit 132 of the recording medium such as a memory card and a hard disk.

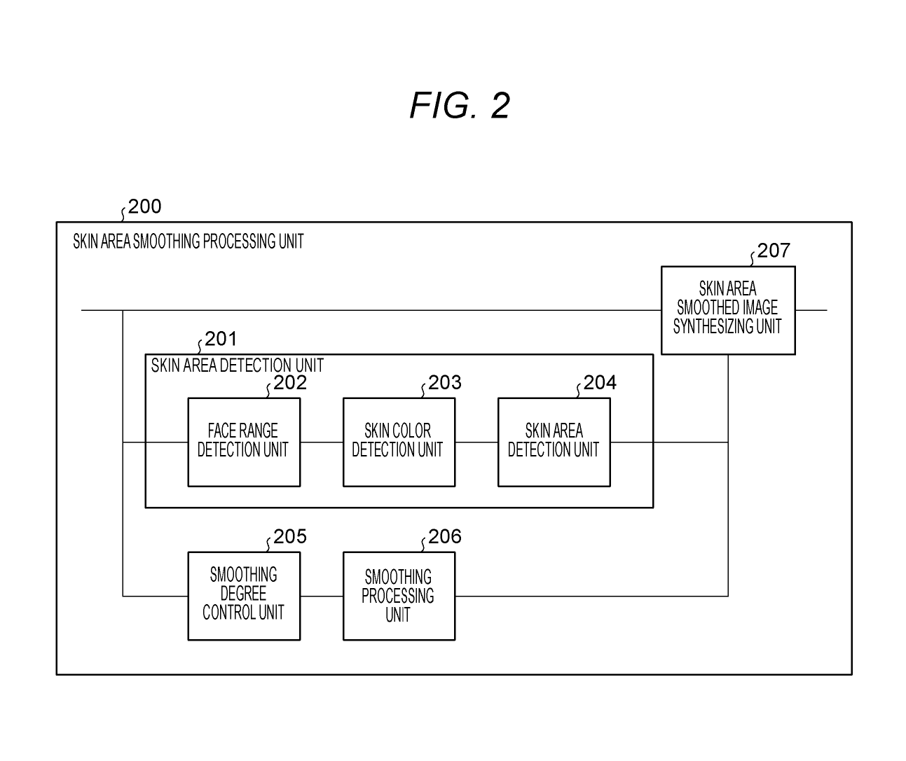

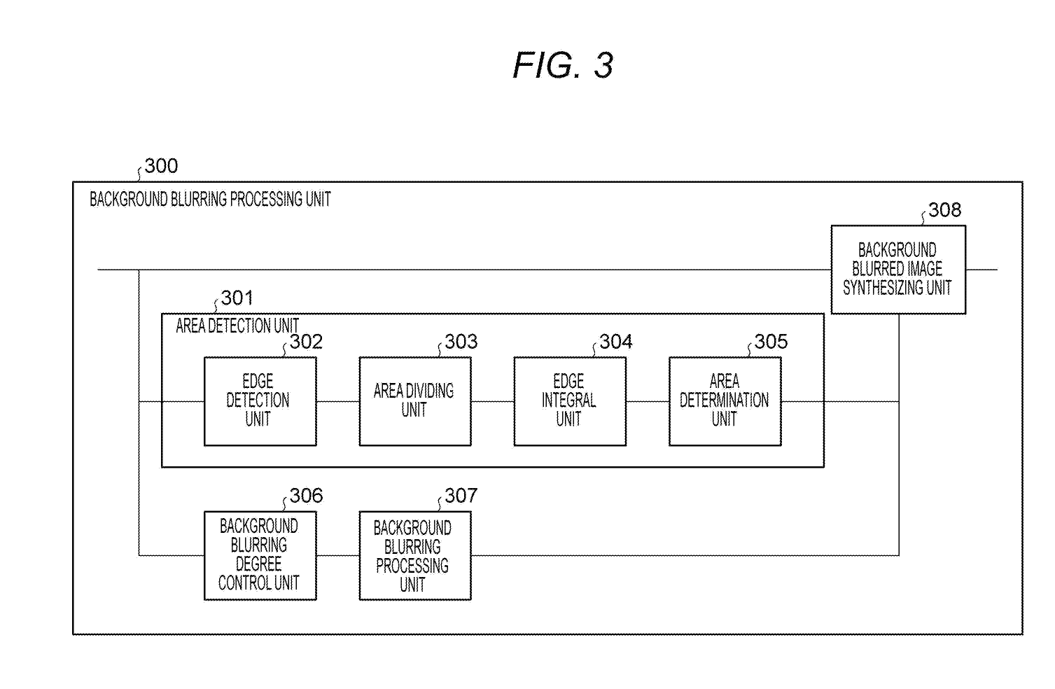

The above image processing circuit 108 is provided with a skin area smoothing processing unit 200 illustrated in FIG. 2 which performs smoothing processing on a skin area of an object person and a background blurring processing unit 300 illustrated in FIG. 3 which performs blurring processing on a background area in an image.

Hereinbelow, the configuration of the skin area smoothing processing unit 200 will be described with reference to FIG. 2. The skin area smoothing processing unit 200 is provided with a skin area detection unit 201. The skin area detection unit 201 includes a face range detection unit 202, a skin color detection unit 203, and a skin area detection unit 204. The skin area smoothing processing unit 200 is further provided with a smoothing degree control unit 205, a smoothing processing unit 206, and a skin area smoothed image synthesizing unit 207.

Hereinbelow, the configuration of the background blurring processing unit 300 will be described with reference to FIG. 3. The background blurring processing unit 300 is provided with an area detection unit 301. The area detection unit 301 is provided with an edge detection unit 302, an area dividing unit 303, an edge integral unit 304, and an area determination unit 305. The background blurring processing unit 300 is further provided with a background blurring degree control unit 306, a background blurring processing unit 307, and a background blurred image synthesizing unit 308.

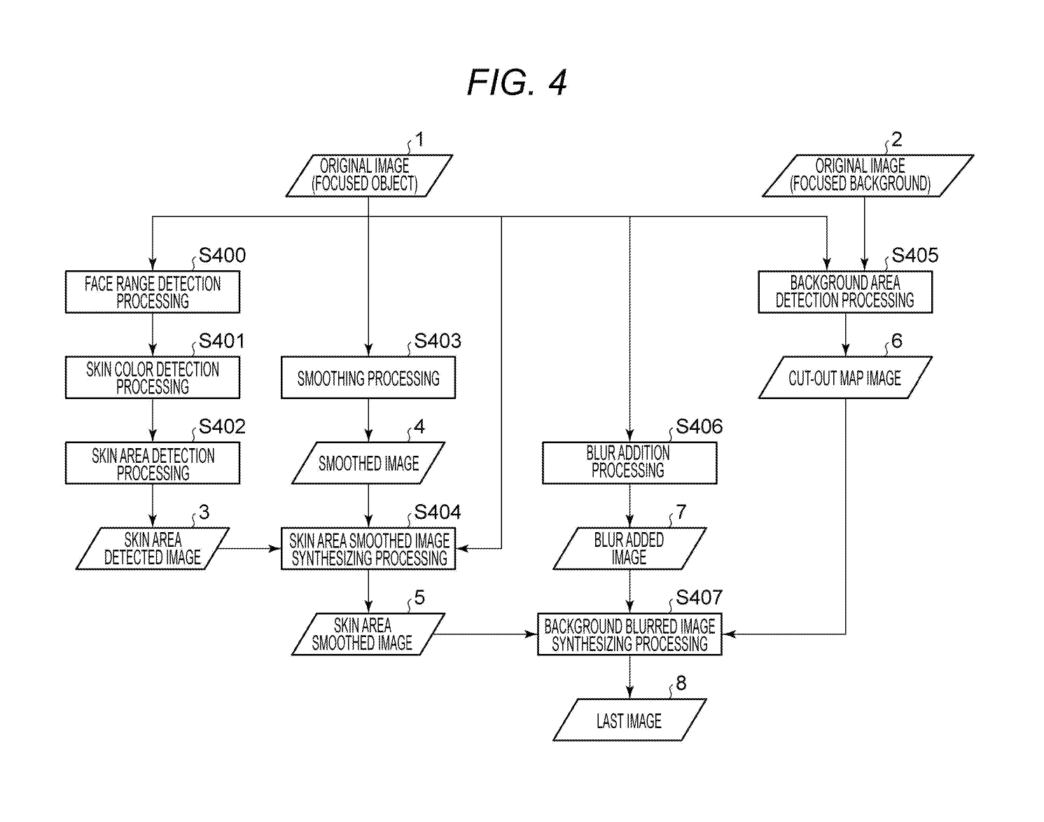

Next, processing in the skin area smoothing processing unit 200 and processing in the background blurring processing unit 300 will be described in detail. FIG. 4 illustrates the flow of the entire processing in the skin area smoothing processing unit 200 and the background blurring processing unit 300 of the present embodiment, the entire processing being executed by the processing units provided in the skin area smoothing processing unit 200 and the background blurring processing unit 300.

An original image 1 and an original image 2 of FIG. 4 are image data items input to the skin area smoothing processing unit 200 and the background blurring processing unit 300. The original image 1 is image data captured by focusing on an object person. The original image 2 is image data captured by focusing on the background side from the state of the original image 1.

Hereinbelow, processing of the skin area smoothing processing unit 200 will be described. The skin area smoothing processing unit 200 performs smoothing processing on a skin area of the object person in the input original image 1. The smoothing processing on the skin area is blurring processing, and will be referred to as smoothing processing hereinbelow.

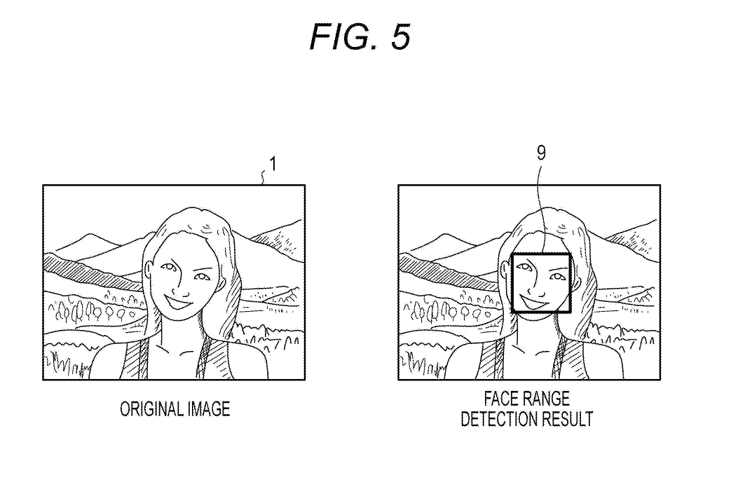

A method of face range detection executed by the skin area detection unit 201 will be described. In face range detection processing S400, the face range detection unit 202 detects a face range 9 of the original image illustrated in FIG. 5. First, the face range detection unit 202 allows a horizontal direction band-pass filter to act on the image data of the original image 1. Then, the face range detection unit 202 allows a vertical direction band-pass filter to act on the processed image data. Edge components are detected from the image data of the original image 1 by the horizontal direction bend-pass filter and the vertical direction band-pass filter.

Then, the face range detection unit 202 performs pattern matching on the detected edge components to extract candidate groups of face parts such as eyes, nose, mouth, and ears. Then, the face range detection unit 202 determines one that satisfies a preset condition (for example, the distance between two eyes and the inclination thereof) as an eye pair and narrows down only one having the eye pair as an eye candidate group from the extracted eye candidate groups. Then, the face range detection unit 202 associates the narrowed eye candidate group with the other face parts (nose, mouth, and ears) corresponding thereto and uses a preset non-face condition filter to thereby detect the face range 9.

The face range detection is not limited to the above method, and may be performed by another detection method. For example, a user manually selects the face range to perform the detection of the face range.

Then, in skin color detection processing S401, the skin color detection unit 203 determines the degree of brightness and color of the skin of the object person (hereinbelow, referred to as a skin color component) on the basis of image information included in the face range 9. For example, an average value of components such as color phase, color saturation, and brightness within the face range 9 may be used as the skin color component. A method for determining the skin color component is not limited to the above method. Skin color information may be determined in a limited range excepting an area other than the skin of the object person such as the eyes and nose in the face range. Alternatively, a histogram of components of the skin color and brightness may be generated, and a component that exceeds a predetermined threshold may be extracted to determine the skin color component.

In skin area detection processing S402, the skin area detection unit 204 detects an area corresponding to the skin of the object person in the original image 1 on the basis of the above skin component and generates a skin area detected image 3. The skin area detected image 3 is an image whose pixel value is determined by the components such as color phase, color saturation, and brightness in the original image 1 and the closeness to the above skin color component. In the present embodiment, the skin area detected image 3 is an image in which a pixel that is closest to the above skin color component has the largest pixel value.

Hereinbelow, smoothing processing on the original image 1 will be described. In smoothing processing S403, the smoothing degree control unit 205 determines a parameter indicating the degree of the smoothing processing (hereinbelow, referred to as a smoothing parameter) by setting of the user. Then, the smoothing processing unit 206 performs smoothing processing on the original image 1 based on the smoothing parameter to generate a smoothed image 4. The smoothing processing is blurring processing, and the smoothing parameter indicates the blurring amount in the blurring processing.

The smoothing processing unit 206 performs filtering processing on the original image 1. The filtering processing is only required to smooth the image. For example, the filtering processing is performed using a moving average filter or a weighted average filter. Further, the degree of the smoothing is determined on the basis of the above smoothing parameter, and the degree of a smoothing effect is changed, for example, by increasing the number of taps in the filtering processing.

A method of the smoothing processing on the original image 1 is not limited to this method. Other methods such as smoothing by resizing the image data may be used.

Although, in the present embodiment, the smoothing parameter is determined by setting of the user, the present disclosure is not limited thereto. For example, a signal characteristic such as unevenness may be measured on the skin area of the object person and a smoothing parameter required to smooth the unevenness to a predetermined level may be automatically determined.

Hereinbelow, image synthesizing processing between the original image 1 and the smoothed image 4 will be described. In skin area smoothed image synthesizing processing S404, the skin area smoothed image synthesizing unit 207 performs image synthesis between the original image 1 and the smoothed image 4 on the basis of the skin area detected image 3 to generate a skin area smoothed image 5.

An example of the image synthesizing processing will be described. The skin area smoothed image synthesizing unit 207 synthesizes image data IMG1 [i, j] of the original image 1 and image data IMG2 [i, j] of the smoothed image 4 on the basis of α [i, j] (0≦α≦1) obtained from a pixel value of the skin area detected image 3 to generate synthesized image data IMG3 [i, j]. That is, the skin area smoothed image synthesizing unit 207 calculates the synthesized image data IMG3 [i, j] by using the following Expression (1). In Expression (1), [i, j] represents each pixel.

[Expression 1]

IMG3[i,j]=IMG1[i,j]*α[i,j]+IMG2[i,j]*(1−α)[i,j] Expression(1)

The synthesized image data IMG3 obtained by the above processing is acquired as a skin area smoothed image 5.

Next, processing of the background blurring processing unit 300 will be described with reference to FIGS. 3 and 4. The background blurring processing unit 300 detects a background area in the original image 1 to generate a cut-out map image 6. Then, blurring processing is performed on the original image 1 to generate a blur added image 7. Then, a last image 8 in which the skin area smoothed image 5 is applied to an area including the object person and the blur added image 7 is applied to the background area is generated by image synthesis.

Hereinbelow, a method for detecting the background area will be described. In background area detection processing S405, the area detection unit 301 detects the background area in the original image 1 to generate the cut-out map image 6.

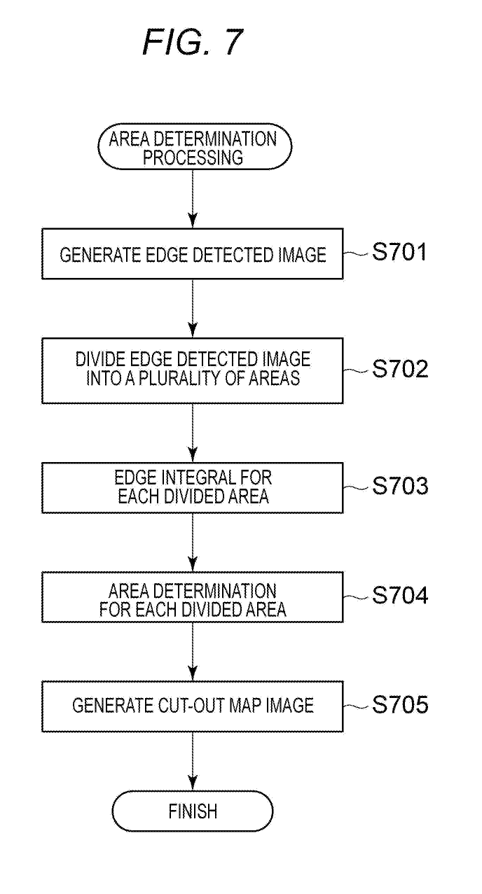

Here, area detection processing performed by the area detection unit 301 will be described with reference to a flowchart of FIG. 7.

In step S701, the edge detection unit 302 detects an edge of the image data of the original image 1 captured by focusing on the object and an edge of the image data of the original image 2 captured by focusing on the background. An example of the edge detection method includes a method in which band-pass filtering is performed on the captured image data to obtain the absolute value to thereby detect the edge of the image data. The edge detection method is not limited to this method, and other methods may be used.

Hereinbelow, an edge image detected from the image data captured by focusing on the object is referred to as object focused side edge image data, and an edge image detected from the image data captured by focusing on the background is referred to as background focused side edge image data.

In step S702, the area dividing unit 303 divides the object focused side edge image data into a plurality of areas and divides the background focused side edge image data into a plurality of areas.

In step S703, the edge integral unit 304 integrates the absolute value of the edge in each of the divided areas.

In step S704, the area determination unit 305 determines whether each divided area is an object area or a background area. In each divided area [i, j], an object focused side edge integral value is represented by EGI1 [i, j] and a background focused side edge integral value is represented by EGI2 [i, j]. The area determination unit 305 evaluates the calculated EGI1 [i, j] and EGI2 [i, j] in each divided area [i, j] to determine whether the EGI1 [i, j] and the EGI2 [i, j] satisfy the relation of the following Expression (2) with respect to a predetermined threshold TH.

[Expression 2]

|EGI1[i,j]÷EGI2[i,j]|≧TH Expression (2)

When the relation of Expression (2) is satisfied, the area determination unit 305 defines the area as the object area. When the relation of Expression (2) is not satisfied, the area determination unit 305 defines the area as the background area.

In step S705, the area determination unit 305 generates the cut-out map image 6 which is capable of determining the object area and the background area on the basis of a result of the area determination in step S704. In the cut-out map image 6, for example, the synthesis ratio is represented by a pixel value of the image data itself. Low-pass filtering may be performed on the cut-out map image 6 in order to make a change in the boundary inconspicuous.

Hereinbelow, background area blurring processing will be described. In background area blurring processing S406, the background blurring degree control unit 306 determines a parameter indicating the degree of a blurring effect (hereinbelow, referred to as a blur addition parameter). Then, the background blurring processing unit 307 performs blurring processing based on the blur addition parameter. Hereinbelow, a method for determining the blur addition parameter will be described.

The image processing apparatus 100 divides an area of a captured image into a plurality of areas in image capture. Then, the image processing apparatus 100 acquires the distance from the image processing apparatus 100 to a point included in each divided area by a ranging unit as a distance information acquiring unit which obtains the distance to a predetermined position. After the image capture, the background blurring degree control unit 306 acquires distance information to the object person and the farthest side distance information in the background area from the acquired distance information. The distance information to the object person is represented by D1, and the distance information to the background is represented by D2.

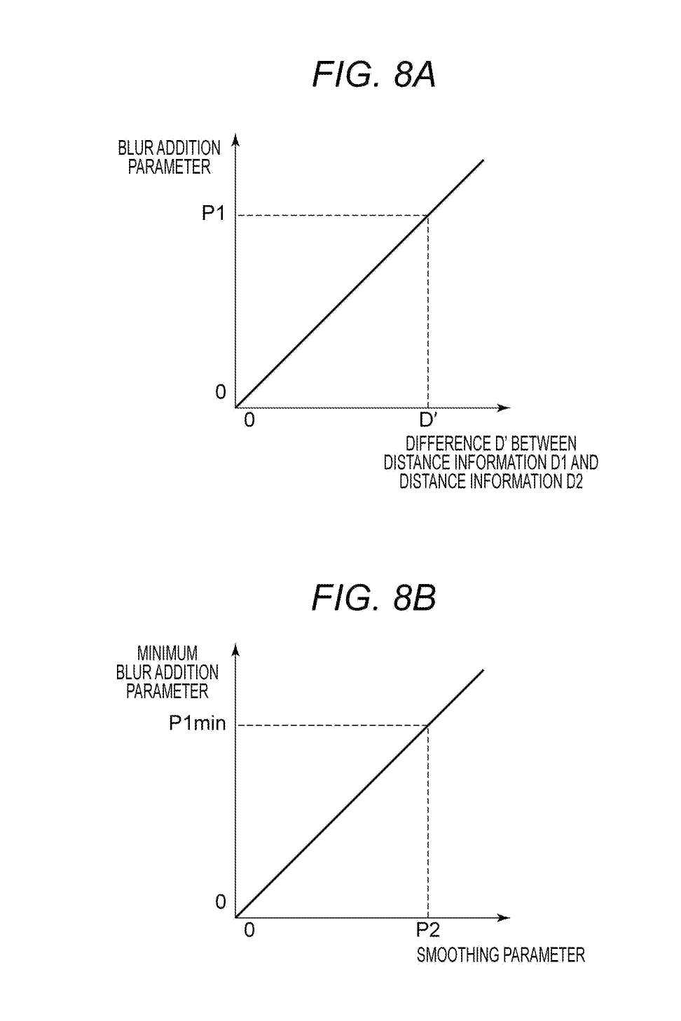

The background blurring degree control unit 306 calculates a difference value D′ between the distance information D1 and the distance information D2. Then, the difference value is checked against a predetermined blur addition amount determination table to determine the blur addition amount. FIG. 8A is a diagram illustrating an example of the blur addition amount determination table. In the table of FIG. 8A, a blur addition parameter P1 is determined by determining the difference value D′.

The table of FIG. 8A may be designed in any manner. A table may be designed for each imaging condition such as the focal length and an aperture value of the imaging apparatus, or a fixed table which is not proportional to the difference value D′ in the distance information may be designed.

Although, in the present embodiment, the farthest side distance information in the background area is used as the distance information D2 to the background, the present disclosure is not limited thereto. For example, an average value of all distance information items included in the background area may be used as the distance information D2 to the background.

Although, in the present embodiment, the blur addition parameter is determined by the difference in the ranging information, the blur addition parameter may be determined using any information acquired from the relationship between the object and the background. For example, the blur addition parameter may be determined by a difference in the depth between the object and the background obtained from the ranging information.

Then, the background blurring degree control unit 306 as a control unit for controlling the blurring amount determines a minimum blur addition parameter P1min on the basis of the above smoothing parameter. The minimum blur addition parameter is a minimum value of the blur addition parameter that gives an impression of the object person whose skin area has been smoothed being in focus equally to or more than the background. FIG. 8B illustrates a table for obtaining the minimum blur addition parameter P1min using the determined smoothing parameter P2 as input. The background blurring degree control unit 306 sets the blur addition parameter P1 to be equal to or more than the minimum blur addition parameter P1min. Accordingly, the blurring amount in the skin area of the object person is set to be equal to or less than the blurring amount in the background area.

The table of FIG. 8B may be designed in any manner. A table may be designed for each imaging condition such as the focal length and the aperture value of the imaging apparatus.

Hereinbelow, blurring processing performed by the background blurring processing unit 307 will be described. The background blurring processing unit 307 performs filtering processing on the image data of the original image 1 on the basis of the above blur addition parameter. The filtering processing is only required to smooth the image. For example, the filtering processing is performed using a moving average filter or a weighted average filter. The degree of the smoothing is determined on the basis of the smoothing parameter. The degree of a smoothing effect is changed, for example, by increasing the number of taps of the filtering processing.

A method of the smoothing processing on the original image 1 is not limited to the above method. Other methods such as smoothing by resizing the image data may be used.

Hereinbelow, image synthesizing processing between the skin area smoothed image 5 and the blur added image 7 will be described. In background blurred image synthesizing processing S407, the background blurred image synthesizing unit 308 performs image synthesis between the skin area smoothed image 5 and the blur added image 7 on the basis of the cut-out map image 6 to generate the last image 8.

Here, an example of the image synthesizing processing will be described. The background blurred image synthesizing unit 308 synthesizes image data IMG1 [i, j] of the skin area smoothed image 5 and image data IMG2 [i, j] of the blur added image 7 on the basis of α [i, j] (0≦α≦1) obtained from a pixel value of the cut-out map image 6 to generate synthesized image data IMG3 [i, j]. That is, background blurred image synthesizing unit 308 calculates the synthesized image data IMG3 [i, j] by using the above Expression (1). In the above, [i, j] represents each pixel. The synthesized image data IMG3 obtained by this processing is acquired as the last image.

In the above, means for controlling the blur degree in the background area (the blurring amount in the background area) on the basis of the smoothing degree in the skin area (the blurring amount in the skin area) determined by the user has been described. In the present embodiment, the blurring amount in the background area is controlled to be larger than the blurring amount in the skin area. Thus, in image processing which simultaneously performs smoothing processing on the skin area and blur addition processing on the background area, it is possible to acquire preferred image data in which the object person does not have a blurred impression by the smoothing processing on the skin area.

The smoothing degree in the skin area may be determined not only by input by the user, but also on the basis of a contrast difference or the frequency characteristic in the skin area of the object person.

### Second Embodiment

In the first embodiment, means for controlling strength/weakness of the blurring effect in the background area on the basis the smoothing degree in the skin area of the object person within the captured image has been described. In a second embodiment, means for controlling the smoothing degree (blurring amount) in the skin area of the object person on the basis of the blur degree (blurring amount) in the background area within the captured image will be described. In the second embodiment, description for the same configuration as the configuration of the first embodiment will be omitted.

In the second embodiment, a blur addition parameter in the background area is determined prior to execution of the smoothing processing S403 in the skin area of FIG. 4. The blur addition parameter is automatically determined by input from the user or by the image processing apparatus 100. For example, in the automatic determination, the blur addition parameter is determined by the positional relationship between the object and the background in image capture as described above.

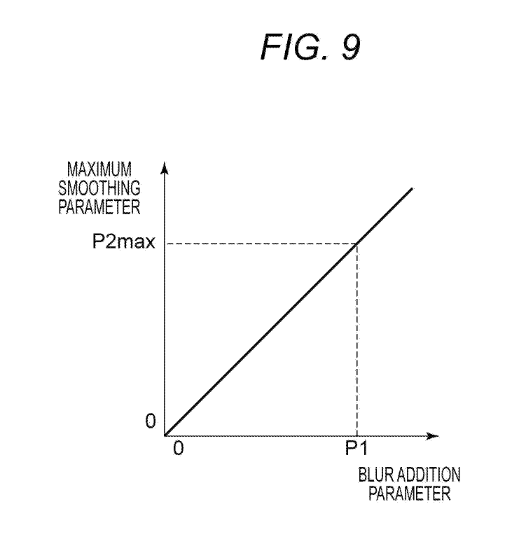

In the smoothing processing S403 of FIG. 4, the smoothing degree control unit 205 as a control unit for controlling the blurring amount determines a maximum smoothing parameter P2max on the basis of the above blur addition parameter (referred to as a blur addition parameter P1). The maximum smoothing parameter is a maximum value of the smoothing parameter that gives an impression of the object person whose skin area has been smoothed being in focus equally to or more than the background. FIG. 9 illustrates a table for obtaining the maximum smoothing parameter P2max using the determined blur addition parameter P1 as input. The smoothing degree control unit 205 sets the smoothing parameter to be equal to or less than the maximum smoothing parameter P2max. Accordingly, the blurring amount in the skin area of the object person is set to be equal to or less than the blurring amount in the background area.

The table of FIG. 9 may be designed in any manner. A table may be designed for each imaging condition such as the focal length and the aperture value of the imaging apparatus.

In the above, means for controlling the smoothing effect in the skin area of the object person on the basis of strength/weakness of the determined blurring effect in the background area has been described. In the present embodiment, in image processing which simultaneously performs smoothing processing on the skin area and blur addition processing on the background area, it is possible to acquire preferred image data in which the object person does not have a blurred impression by the smoothing processing on the skin area.

As described above, the minimum value of the blurring amount applicable to the background area is calculated on the basis of the blurring amount in the skin area in the first embodiment, and the maximum value of the blurring amount applicable to the skin area is calculated on the basis of the blurring amount in the background area in the second embodiment. However, it is only required that the blurring amount in the skin area be equal to or less than the blurring amount in the background area. Therefore, the blurring amount in the skin area and the blurring amount in the background area are not necessarily set to the maximum value and the minimum value.

A mode in which the blurring amount in either the skin area of the object person or the background area is determined depending on the blurring amount in the other area has been described. However, the blurring amount in each of the areas may be independently set as long as the relationship in which the blurring amount in the skin area is equal to or less than the blurring amount in the background area is satisfied.

The present disclosure is achieved also by executing the following processing, specifically, processing in which software (program) which achieves the functions of the above embodiments is supplied to a system or an apparatus through a network or various recording mediums and a computer (or a CPU (central processing unit) or MPU (micro processing unit)) of the system or the apparatus reads a program code to execute the processing. In this case, the program and the recording medium storing the program constitute a part of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, MPU, etc.) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-153296, filed Jul. 28, 2014, which is hereby incorporated by reference herein in its entirety.

What is claimed is:

1. An image processing apparatus comprising:
an image acquiring unit configured to acquire an image;
a blurring processing unit configured to apply blurring processing to a skin area of an object person and a background area included in the image; and
a control unit configured to control a blurring amount of the blurring processing for each of the areas,
wherein the control unit controls the blurring amount of the blurring processing so that a blurring amount in the skin area of the object person becomes smaller than a blurring amount in the background area.

2. The image processing apparatus according to claim 1, further comprising:
a setting unit configured to set the blurring amount in either the skin area of the object person or the background area,
wherein the control unit determines, depending on the blurring amount in either the skin area of the object person or the background area set by the setting unit, the blurring amount in the other area.

3. The image processing apparatus according to claim 1, further comprising:
a distance information acquiring unit configured to acquire distance information of an object included in the image,
wherein the control unit determines the blurring amount in the background area based on a difference between a distance to the object person and a distance to a background.

4. The image processing apparatus according to claim 3,
wherein the control unit determines the blurring amount in the background area so that the blurring amount in the background area increases as the difference between the distances increases.

5. The image processing apparatus according to claim 1, further comprising:
a face detection unit configured to detect a face range from the image; and
a skin area detection unit configured to acquire skin color information of the object person using color information of the face range and detect the skin area of the object person based on the skin color information.

6. The image processing apparatus according to claim 1,
wherein the image is a first image focused on the object person, and
the image processing apparatus further comprises an area determination unit configured to specify an area of the object person and the background area using the first image and a second image focused on a background, the second image being different from the first image.

7. The image processing apparatus according to claim 6, further comprising:
a synthesizing unit configured to synthesize an image obtained by applying blurring processing to the background area in the first image and an image obtained by applying blurring processing to the skin area of the object person in the first image.

8. An image processing method comprising:
an image acquiring step for acquiring an image;
a blurring processing step for applying blurring processing to a skin area of an object person and a background area included in the image; and
a control step for controlling a blurring amount of the blurring processing for each of the areas,
wherein the blurring amount of the blurring processing is controlled in the control step so that a blurring amount in the skin area of the object person becomes smaller than a blurring amount in the background area.

9. An imaging apparatus comprising:
an imaging unit; and
an image processing unit configured to perform image processing on an image acquired by image capture by the imaging unit,
wherein the image processing unit includes:
a blurring processing unit configured to apply blurring processing to a skin area of an object person and a background area included in the image; and
a control unit configured to control a blurring amount of the blurring processing for each of the areas, wherein the control unit controls the blurring amount of the blurring processing so that a blurring amount in the skin area of the object person becomes smaller than a blurring amount in the background area.
